(19) United States
(12) Patent Application Publication
(10) Pub. No.: US 2013/0134871 A1
(43) Pub. Date: May 30, 2013

(54) POWER SUPPLY CONTROL DEVICE FOR AN ELECTRONIC PRODUCT

(71) Applicant: Yung-Cheng CHAN, New Taipei City (TW)

(72) Inventor: Yung-Cheng CHAN, New Taipei City (TW)

(73) Assignee: YFT Tech. Co., Ltd., New Taipei City (TW)

(21) Appl. No.: 13/304,466

(22) Filed: Nov. 25, 2011

(51) Int. Cl. H01J 7/44; H01J 5/50

(52) U.S. Cl. 315/33; 315/51

(57) ABSTRACT

The present invention provides a power supply control device for an electronic product, which device includes a socket and a power supply controller; wherein the socket is provided on the electronic product, electricity runs between an electric circuit board of the electronic product and a power supply, and has a leading/insertion slot; the power supply controller can be insertion connected into the leading/insertion slot, and at least includes a control chip controlling the socket to put out electric power to an electric circuit board of the electronic product, the electronic product can be independent in the technique of treating electric power supplying, and can be micronized and modularized, and can be mounted in a more simple and faster way, further is benefit to easy insertion and extraction directly; thereby cost of maintenance of the electronic product can be lowered.

### BACKGROUND OF THE INVENTION

1. Field of the Invention

The present invention relates to a power supply control device for an electronic product, and especially to a power supply control device which has an electronic element for power supply control and is provided independently of an electronic product, and which can independently be mounted, maintained and changed.

2. Description of the Prior Art

As to the technique of treating power supplying of conventional electronic equipment, after municipal electric power is input, according to electricity requirement of electronic products, mostly an electronic element for power supply control is used to conduct transforming or stabilizing voltage or alternate-direct current transforming etc., then an electronic product can be driven. The electronic element having conducted transforming or stabilizing voltage or alternate-direct current transforming always is integrated directly on an electric circuit board in the electronic product for the purpose of controlling the power supply.

Electronic products of nowadays get more and more precise during development, many electronic products having therein electronic elements for power supply control include control chips (or driving chips) which are in the types of IC, MCU etc. in practice, thereby we can see these control chips and the electronic elements for power supply control on electric circuit boards of many electronic products.

However, the control chips and the electronic elements for power supply control normally are the elements subject to being damaged, or to becoming inferior on their electric circuit boards of the electronic products; when the control chips and the electronic elements for power supply control are out of order or fail to pass the examination during leaving the factory, the whole electric circuit board examined shall be detached or changed, even the control chip on it shall be replanted, this results consumption of manpower, and makes higher cost of material.

For example, when an electronic product is an LED lamp, and the power supply controller (driving control IC) of it is damaged, a consumer is not able to change or repair by himself, it is a time and work wasting thing to sent the power supply controller back to the maintaining station for changing the driving control IC or the electronic elements for power supply control, and thereby is uneconomic.

Particularly if the power supply circuit and the power supply controller are still built in the product, once the LED lamp is out of order, the consumer and the manufacturer normally do not study in detail whether the electronic elements for power supply control is damaged, but just have the electric circuit board changed as a whole, or even discard the whole lamp set to waste resource.

In view of these, the inventor of the present invention designed a unique power supply control device for an electronic product, power supply controller of the power supply control device is designed to be a removable part, when the electronic product is out of order, a user can change the power supply controller by himself in order to repair the later in a mode which is faster; more convenient and cost lower, and can prolong the life of use of the electronic product.

### SUMMARY OF THE INVENTION

The object of the present invention is to provide a power supply control device for an electronic product, an extremely important power supply controller on a power supply end of the electronic product can be provided independently, and the electronic product can be changed and removed/inserted through a simple and fast mounting means, this can reduce the cost of mounting and changing the power supply controller in production and maintenance, also the operation of mounting and changing can be faster and more convenient.

In order to achieve the above stated object, the power supply control device of the present invention includes a socket and a power supply controller; wherein the socket is provided on the electronic product, electricity runs between an electric circuit board and a power supply, and has a leading/insertion slot which is exposed on the electronic product; the power supply controller can be connected to the socket, at least includes a control chip for controlling the output electric power from the socket to the electronic product.

When in practicing, the power supply controller is in the shape of a sheet or any of other shapes that is benefit to easy insertion and extraction, one end (the insertion/extraction end) of it is provided with a plurality of electricity conducting pins; the leading/insertion slot is provided therein with a plurality of another set of electricity conducting pins in correspondence by position with the former electricity conducting pins for electrically connecting the two sets of pins, in order that the power supply controller can be designed in an independent mode, in a micro size and in a modularized mode.

And in practicing, the way of insertion/extraction of the power supply controller in relation to the leading/insertion slot (in addition to the way of using friction to have the power supply controller squeezed and positioned after insertion) can also have the leading/insertion slot designed to become an elastic push-push slot, in order to make the power supply controller be operated in an elastic push-push mode.

The followings are examples of application of the present invention:

The electronic product can be an LED lamp or an LED light emitting module of a lamp set, for instance: an LED lamp tube, an LED lamp bulb, a desk lamp, an embedded lamp, and an LED light emitting module of a road lamp etc.; in practicing, the control chip of the power supply controller can be an LED driver IC, the above mentioned socket is provided at an appropriate position on the LED lamp or the light emitting module, the electric circuit board of the lamp and the power supply are electrically connected with each other, and the leading/insertion slot is exposed to the outside; when the power supply controller which is relatively subjected to damaging is out of order, a user needs only to change the power supply controller via the leading/insertion slot directly, and the later can be fast repaired.

Similarly, the present invention can be used for a 3C electronic product such as a multimedia player, a TV etc.; so long that the socket is provided at an appropriate position on the electronic product to make exposition of the leading/insertion slot, power supply for the electronic product can be controlled through the power supply controller.

And the stated socket can also be provided on a battery module of the electronic product to make exposition of the leading/insertion slot of the socket; electric power can be put out to the electronic product by controlling the battery module of the power supply controller. This example is applicable to those portable devices having battery modules such as a notebook, a mobile phone, a portable display and a GPS navigation device etc., the range of applicability is very large.

As compared to the prior art, the present invention is advantageous in that: it makes the important power supply controller in the electronic element for power supply control be produced in an independent mode, in a micro size and in a modularized mode; this not only can increase the efficiency of production, but also can make fast changing when the power supply controller is damaged, in order to eliminate the problem that the electric circuit board in the electronic product must be detached during repairing, and to lower the cost and time for repairing.

The present invention will be apparent according to its technical means and after reading the detailed description of the preferred embodiment thereof in reference to the accompanying drawings.

### BRIEF DESCRIPTION OF THE DRAWINGS

FIG. 1 is a perspective schematic view showing an LED lamp tube in which the present invention is applied;

FIG. 2 is a perspective schematic view showing the structure of the present invention;

FIG. 3 is a schematic view showing an LED lamp bulb in which the present invention is applied;

FIG. 4 is a schematic view showing an LED desk lamp in which the present invention is applied;

FIG. 5 is a schematic view showing an LED projecting lamp in which the present invention is applied;

FIG. 6 is a schematic view showing an LED light emitting module of a road lamp in which the present invention is applied;

FIG. 7 is a schematic perspective view showing a multimedia display in which the present invention is applied;

FIG. 8 is a schematic perspective view showing a battery module of an electronic product in which the present invention is applied;

FIG. 9 is a perspective schematic view showing the structure of a battery module of an electronic product in which the present invention is applied.

### DETAILED DESCRIPTION OF THE PREFERRED EMBODIMENT

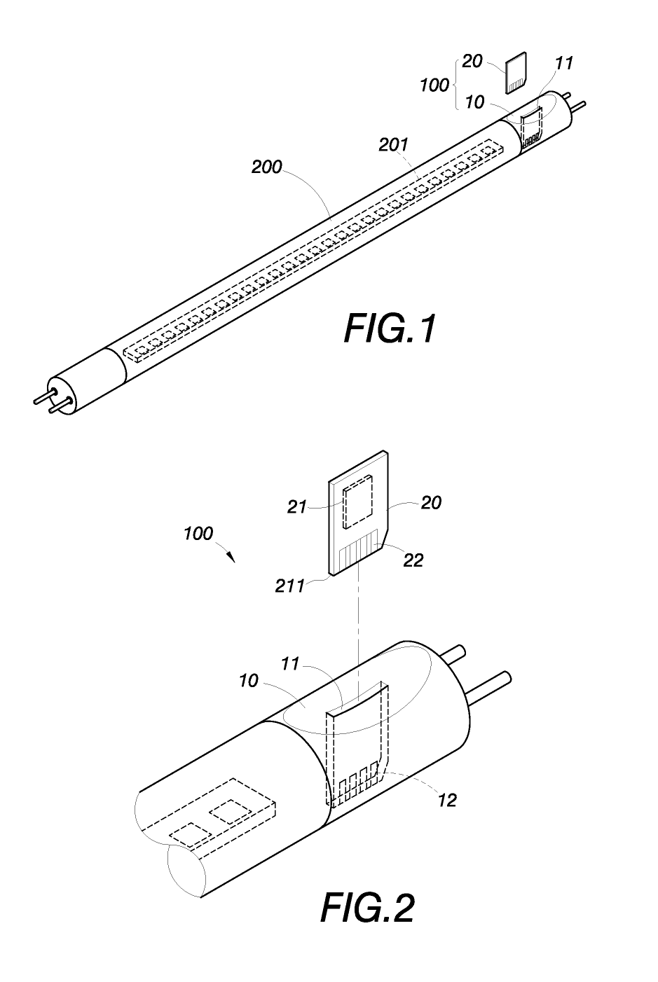

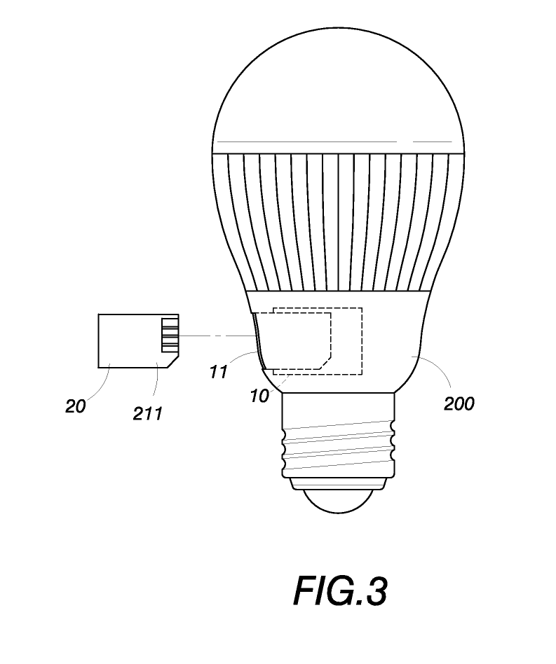

Referring firstly to FIGS. 1 and 2 showing two perspective schematic views of the first embodiment of the present invention, as shown in the drawings that the power supply control device 100 of the present invention includes a socket 10 and a power supply controller 20; in the drawings, the socket 10 is provided on an electronic product 200, an electric circuit board 201 of the electronic product 200 and the power supply are electrically connected with each other, and the socket 10 includes a leading/insertion slot 11 exposed to the outside of the electronic product 200; the power supply controller 20 can be insertion connected into the leading/insertion slot 11, and at least includes a control chip 21 controlling the socket 10 to put out electric power to the electric circuit board 201 of the electronic product 200, the control chip 21 can be an IC, an MCU or an LED control chip etc.

In the drawing, the above mentioned electronic product 200 is an LED lamp tube, the socket 10 is provided on one end of the lamp tube and has the leading/insertion slot 11 exposed to the outside; the control chip 21 of the power supply controller 20 is an LED driver IC, it is in a sheet shape apparently, one end of which is an insertion/extraction end 211 being provided with a plurality of electricity conducting pins 22; the leading/insertion slot 11 is provided therein with a plurality of another set of electricity conducting pins 12 in correspondence by position with the former electricity conducting pins 22 for electrically connecting the two sets of pins 12, 22, in order that the power supply controller 20 can be micronized and formed an independent part. In practicing, the power supply controller 20 can not be limited to the sheet shape, it can be a post, a rod shape etc., in order that a user can easily operate in insertion and extraction.

When in practical application, in addition to directly squeeze the power supply controller 20 to be fixedly positioned in the leading/insertion slot 11, the leading/insertion slot 11 can be an elastic push-push slot in order to render the power supply controller 20 to be inserted and extracted in a fast elastic push-push mode.

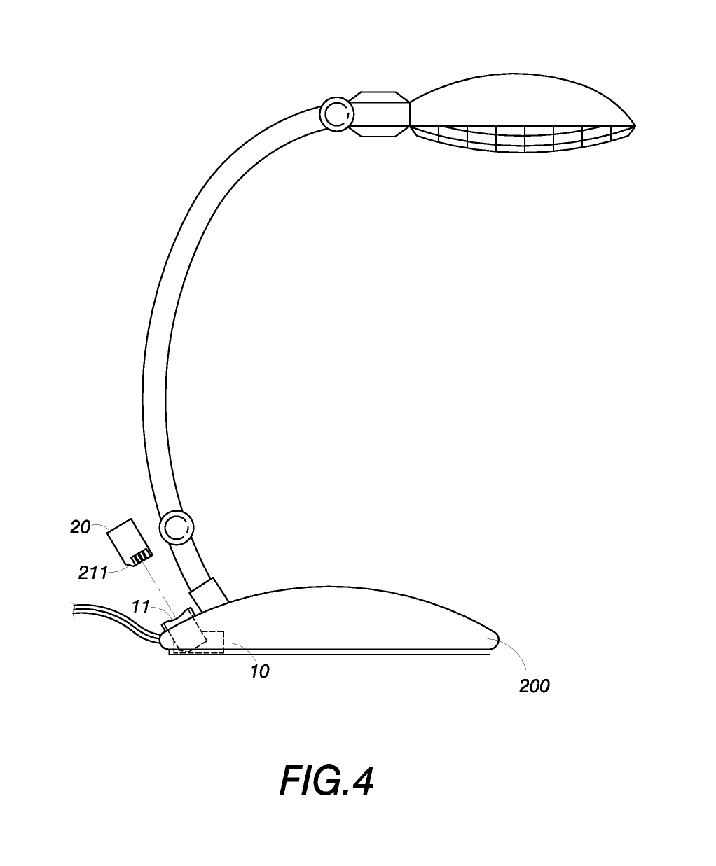

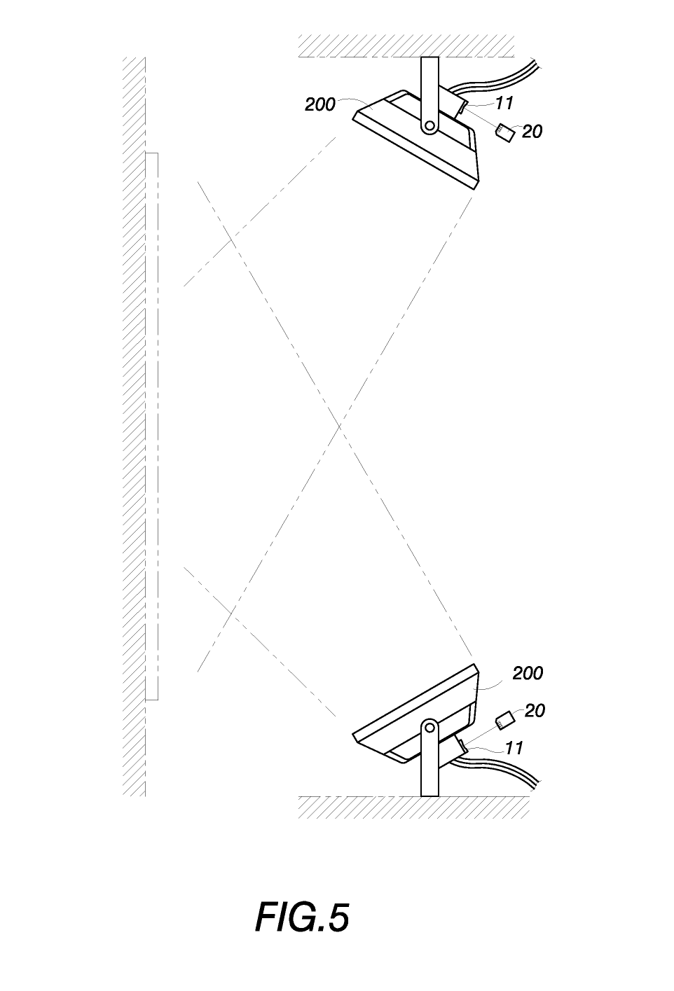

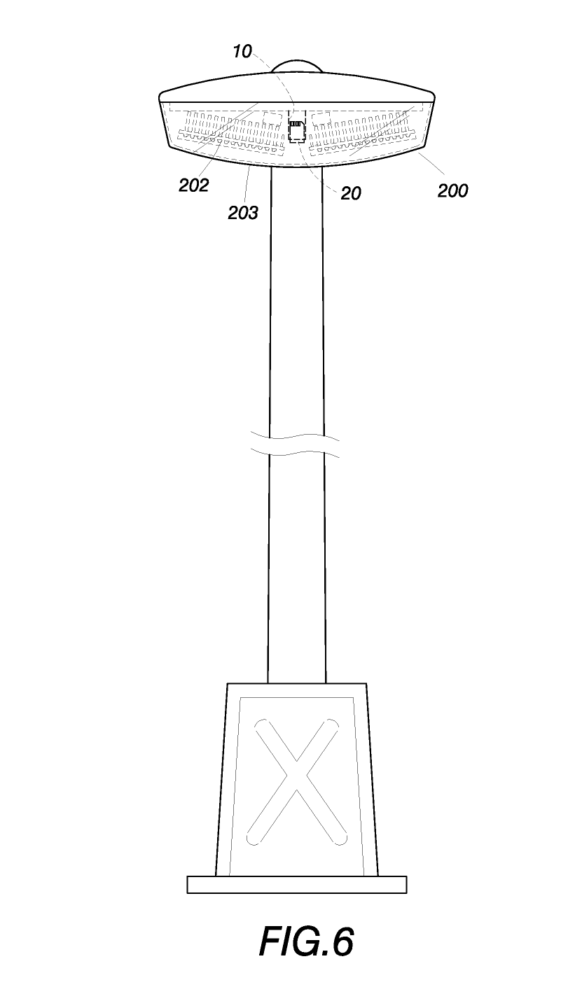

In addition to the LED lamp tube, as shown in FIGS. 3-6, in practicing, the above mentioned electronic product 200 can also be any kind of LED lamp or an LED light emitting module 202 of a lamp set, such as an LED lamp bulb shown in FIG. 3, an LED desk lamp in FIG. 4, an LED projection lamp or embedded lamp shown in FIG. 5, an LED light emitting module 202 of a lamp set (road lamp) shown in FIG. 6; the position provided of it is not limited to that at the circumference of the power supply. For example, the electronic product 200 in FIG. 4 is an LED desk lamp; its socket 10 is provided on the base of the LED desk lamp. While as shown in FIG. 6, the electronic product 200 is an LED light emitting module 202 of a road lamp, by the fact that the road lamp is provided outside of a house, it needs to be designed for water proofing, the LED light emitting module 202 and the socket 10 are provided both in a lamp shade 203, so that when the lamp shade 203 is detached, maintenance work can be done very conveniently.

With the above structure, when the electronic product 200 is out of order, a maintaining person can check up whether the power supply controller 20 is out of order by removing and checking the power supply controller 20, if it is out of order, the work of eliminating the fault is just the work of direct insertion/extraction for changing the power supply controller 20. By such a simple changing of the power supply controller 20 for repairing, not only the working hour can be largely reduced, but also the material and cost of consuming for repairing can both be reduced.

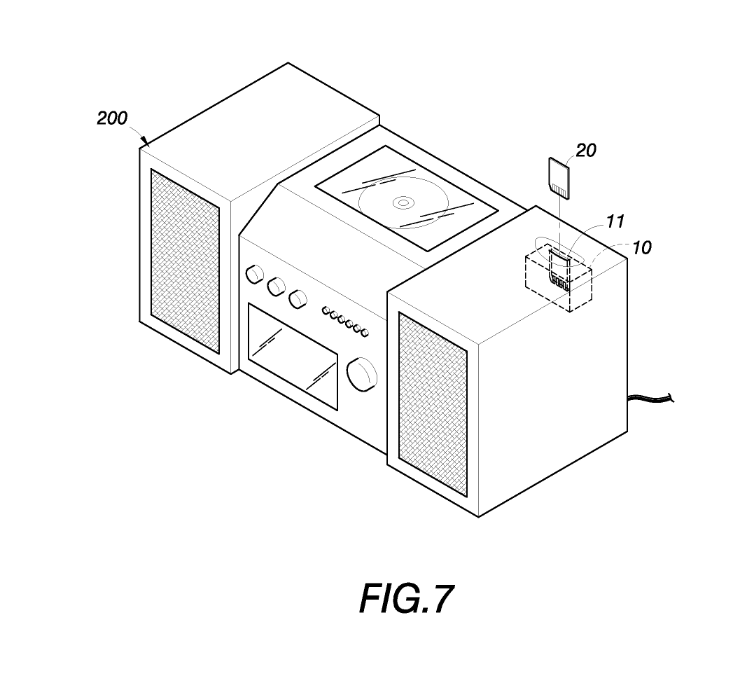

Referring to FIG. 7, in addition to a lamp set, with the above mentioned feature that the leading/insertion slot 11 and the power supply controller 20 of the socket 10 can be fast inserted and extracted, the power supply control device 100 of the present invention can be widely used on those electronic products 200 needing to be provided with power supply controllers 20, for instance, on a multimedia display, a hi-fi, a video-acoustic display, a TV etc.; the electronic product 200 as shown in the drawing is a hi-fi; other embodiments are same in technique as the above stated embodiment, and no further narration is required here.

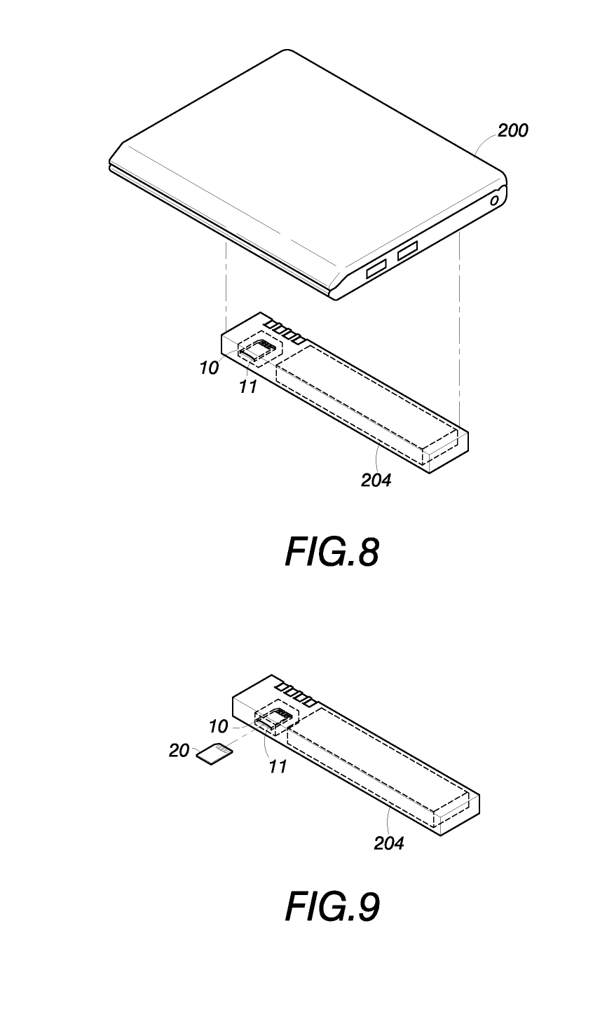

Referring to FIGS. 8 and 9, the electronic product 200 shown in them are respectively a notebook, a mobile cell phone, a portable display, a GPS navigation device etc.; the socket 10 is provided on battery modules 204 of the electronic products 200. When a power supply controller 20 is insertion connected to a socket 10, a battery module 204 is controlled to put out electric power to an electronic product 200, by cooperation of a leading/insertion slot 11 with the power supply controller 20, the power supply controller 20 can present its feature of being independently changed over; and taking advantage of the feature of being able to be detached in an independent mode, to be micronized and to be modularized of the power supply controller 20, the electronic product 200 is easier and more convenient in maintaining concerning its electric power supplying; other embodiments are same in technique as the above stated embodiment, and no further narration is required here.

Additionally, by the fact that the power supply controller 20 can be detached in an independent mode, when it is detached in some particular situation, the electronic product 200 is unable to be used; this can also helpful for management of the electronic product 200, i.e., only the user owning the power supply controller 20 can use the electronic product 200 by having the power supply controller 20 inserted in position by the user.

The embodiments given and the drawings depicted are only for illustrating the preferred embodiments of the present invention, and not for giving any limitation to the scope of the present invention. It will be apparent to those skilled in this art that various equivalent modifications or changes without departing from the spirit, scope and characteristic of this invention shall fall within the scope of the appended claims and are intended to form part of this invention.

1. A power supply control device for an electronic product, said device includes a socket and a power supply controller; wherein said socket is provided on an electronic product, an electric circuit board of said electronic product and a power supply is electrically connected with each other, and said socket includes a leading/insertion slot; said power supply controller is insertion connected into said leading/insertion slot, and at least includes a control chip controlling said socket to put out electric power to said electronic product.

2. The power supply control device for an electronic product as in claim 1, wherein: one end (which is an insertion/extraction end) of said power supply controller is provided with a plurality of electricity conducting pins; said leading/insertion slot is provided therein with a plurality of another set of electricity conducting pins electrically connecting with said former mentioned electricity conducting pins.

3. The power supply control device for an electronic product as in claim 2, wherein: said leading/insertion slot is an elastic push-push slot.

4. The power supply control device for an electronic product as in claim 3, wherein: said leading/insertion slot is exposed on said electronic product.

5. The power supply control device for an electronic product as in claim 1, wherein: said electronic product is an LED lamp, said control chip is an LED driver IC.

6. The power supply control device for an electronic product as in claim 5, wherein: one end (which is an insertion/extraction end) of said power supply controller is provided with a plurality of electricity conducting pins; said leading/insertion slot is provided therein with a plurality of another set of electricity conducting pins electrically connecting with said former mentioned electricity conducting pins.

7. The power supply control device for an electronic product as in claim 6, wherein: said leading/insertion slot is an elastic push-push slot.

8. The power supply control device for an electronic product as in claim 7, wherein: said leading/insertion slot is exposed on said electronic product.

9. The power supply control device for an electronic product as in claim 1, wherein: said electronic product is an LED light emitting module of a lamp set, said control chip is an LED driver IC.

10. The power supply control device for an electronic product as in claim 9, wherein: one end (which is an insertion/extraction end) of said power supply controller is provided with a plurality of electricity conducting pins; said leading/insertion slot is provided therein with a plurality of another set of electricity conducting pins electrically connecting with said former mentioned electricity conducting pins.

11. The power supply control device for an electronic product as in claim 10, wherein: said leading/insertion slot is an elastic push-push slot.

12. The power supply control device for an electronic product as in claim 1, wherein: said electronic product is a multimedia display.

13. The power supply control device for an electronic product as in claim 12, wherein: one end (which is an insertion/extraction end) of said power supply controller is provided with a plurality of electricity conducting pins; said leading/insertion slot is provided therein with a plurality of another set of electricity conducting pins electrically connecting with said former mentioned electricity conducting pins.

14. The power supply control device for an electronic product as in claim 13, wherein: said leading/insertion slot is an elastic push-push slot.

15. The power supply control device for an electronic product as in claim 14, wherein: said leading/insertion slot is exposed on said electronic product.

16. The power supply control device for an electronic product as in claim 1, wherein: said socket is provided on a battery module of said electronic product to render electric power to be put out to said electronic product by controlling said battery module.

17. The power supply control device for an electronic product as in claim 16, wherein: one end (which is an insertion/extraction end) of said power supply controller is provided with a plurality of electricity conducting pins; said leading/insertion slot is provided therein with a plurality of another set of electricity conducting pins electrically connecting with said former mentioned electricity conducting pins.

18. The power supply control device for an electronic product as in claim 17, wherein: said leading/insertion slot is an elastic push-push slot.

19. The power supply control device for an electronic product as in claim 18, wherein: said leading/insertion slot is exposed on said battery module of said electronic product.
